(19) United States
(12) Patent Application Publication
(10) Pub. No.: US 2015/0354955 A1
(43) Pub. Date: Dec. 10, 2015

(54) Corner Level

(71) Applicant: Stephane Diaz, Asheville, NC (US)

(72) Inventor: Stephane Diaz, Asheville, NC (US)

(21) Appl. No.: 14/615,987

(22) Filed: Feb. 6, 2015

Related U.S. Application Data
(60) Provisional application No. 61/937,164, filed on Feb. 7, 2014.

(51) Int. Cl. G01C 9/34

(52) U.S. Cl. CPC G01C 9/34

(57) ABSTRACT

A level apparatus includes first, second, and third segments, and a level-indicating device associated with one of the segments. Each segment has first and second ends; smooth, fiat, parallel top and bottom surfaces; and smooth, flat, parallel front and back surfaces. The ends of the segments are joined to form a fixed triangular structure among the segments. The level-indicating device is arranged to provide an indication of a level orientation of at least one of the surfaces of the segment with which it is associated. At least one segment can include markings indicating distance measurement units. The markings can include numerical indicia.

### FIELD OF THE INVENTION

The invention relates to leveling tools used by carpenters, framers, cabinet makers, tile setters, masons, and the like.

### BACKGROUND OF THE INVENTION

Levels are tools that are commonly used by those in various professions to mark a level line or surface, or to determine the orientation of a plane with respect to a level plane. Typically, such a levelling tool is a straight length of material such as plastic, metal, or wood that includes a level indicator. A typical level indicator is a closed vial that is partially filled with a liquid and a gas bubble in the liquid. The vial is marked so that as the level is moved, the position of the bubble within the liquid in the vial as measured by the markings indicates the orientation of the level. For example, a vial that is arranged longitudinally with respect to the length of the level will indicate a level orientation of the tool when the bubble is centered within the vial.

A carpenter would use a level, for example, to check the orientation of a surface of a structure before mounting it to a wall. Likewise, a mason would check the level of a top surface of a wall during construction. Corners can present complications, however. At a corner, two surfaces meet at an angle, usually a right angle. In most cases, each surface must be level, and the surfaces must also be level with respect to each other.

For example, a carpenter installing a chair rail must be sure that the rail is level as it is mounted to a wall. However, rails mounted on adjacent walls meet in a corner, where both must be level and mounted at the same level. Therefore, three level measurements must be taken to assure this: one along each rail, and one across both rails. This process can be time-consuming, often requires at least two people to accomplish, and presents opportunity for mistake. Likewise, framers and cabinet makers face the same situation at frame corners, complicated by the fact that the corner assessment usually involves a horizontal component and a vertical component. A mason also has to deal with a similar situation, for example, at wall corners, as do tile setters.

A levelling tool that can be used by a single person to quickly and accurately make an assessment of orientation along the sides of and across corners would be advantageous.

### BRIEF SUMMARY OF THE INVENTION

According to an aspect of the invention, a level apparatus includes first, second, and third segments, and a level-indicating device associated with one of the segments. Each segment has first and second ends, parallel top and bottom surfaces, and parallel front and back surfaces. Preferably, these surfaces are smooth and flat. The ends of the segments are joined to form a fixed triangular structure among the segments. The level-indicating device is arranged to provide an indication of a level orientation of at least one of the surfaces of the segment with which it is associated.

The first and second segments can be joined together, for example, at a 90 degree angle, and in this case the level-indicating device can be associated with the third segment.

The level-indicating device can be a first level-indicating device associated with the first segment, and the level apparatus can also include a second level-indicating device that is associated with the second segment. The level apparatus can also include a third level-indicating device that is associated with the third segment. In general, each segment can have one level-indicating device, multiple level-indicating devices, or no level-indicating device at all, as long as at least one of the segments has at least one level-indicating device.

Any level-indicating device can be attached to a surface of the segment or recessed within the segment.

The level-indicating device can include a vial.

At least one segment can include markings indicating distance measurement units. The markings can include numerical indicia.

### BRIEF DESCRIPTION OF THE DRAWINGS OF THE INVENTION

FIG. 1 shows a top view of an exemplary embodiment of the level device.

FIG. 2 shows an end view of the exemplary embodiment of the level device directed at the hypotenuse.

FIG. 3 shows an oblique view of the exemplary embodiment of the level device.

### DETAILED DESCRIPTION OF THE INVENTION

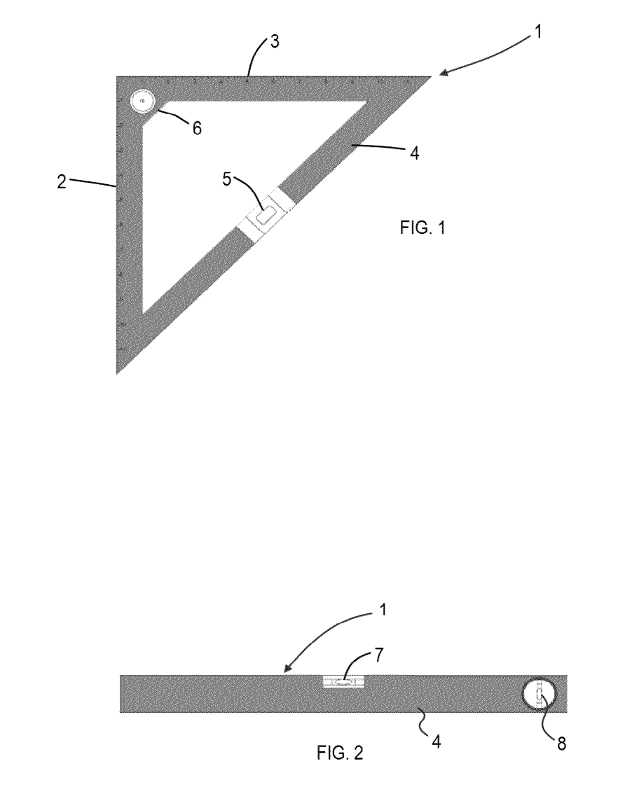

The invention is a three-sided level, preferably in the form of a closed triangle. As shown in the FIGS. 1-3, an exemplary embodiment is fabricated in the shape of a right triangle. That is, two segments of the level are joined at a right angle, and the third segment joins the opposite ends of the first two segments. In the embodiment shown in the figures, the level is an equilateral right triangle, in which one angle is a right angle and the other two are 45 degree angles, and therefore the two shorter segments are of equal length. It will be apparent to one of skill in the art that other right triangles, such as a 30-60-90 triangle arrangement, are possible and can be advantageous. Although preferred embodiments will include a right angle, this is not necessary within the scope of the invention. That is, triangles of any proportion and size are included within the spirit and scope of the invention.

As shown in FIG. 1, the level apparatus 1 includes first, second, and third segments 2-4, and a level-indicating device 5 associated with at least one of the segments. Each segment has first and second ends, parallel top and bottom surfaces, and parallel front and back surfaces. Preferably, these surfaces are flat and smooth, to facilitate accurate level measurements. The ends of the segments are joined to form the fixed triangular structure shown in FIG. 1. The level-indicating device 5 is arranged to provide an indication of a level orientation of at least one of the surfaces of the segment with which it is associated.

The segments can be joined to form a triangle of any size, and at various angles such that the lengths of the segments vary with respect to each other. The first and second segments 2, 3 shown in FIG. 1 are joined together at a 90 degree angle, and are shown to be of about equal lengths. This is not necessarily the case, however, and the triangle can be arranged with different angles to suit the particular application.

The level-indicating device shown in FIG. 1 is associated with the third segment 4. However, level-indicating devices can be associated with any of the segments, alone or in combination, or all of the segments, as desired. Further, any segment can include more than one level-indicating device. For example, FIG. 2 shows a view of the third segment 4 that has two level-indicating devices 7, 8. One level-indicating device 7 is recessed in a top surface of the segment 4. The other level-indicating device 8 is attached to a side surface of the segment 4. Level-indicating devices can be recessed into a surface as shown in FIG. 2, and/or can be disposed within a through-hole aperture so that the device can be viewed from either parallel surface abutting the aperture.

As shown in the exemplary embodiment of FIG. 2, the level-indicating device is a vial. However, the disclosed invention is not limited to a vial-type level-indicating device, and any type of level indicator know to those of skill in the art may he substituted within the contemplate scope of the invention. Further, although the exemplary level indicators are either aligned or perpendicular to the segment surfaces, level indicators at other angles can be associated with the segments as well. For example, level indicators can be arranged at 45 degrees with respect to a segment surface, to facilitate application of features at 45 degrees from a level plane. The angle of the level-indicating device can be made adjustable if desired.

Thus, one or more vials as described above, or other type of level indicators, can be attached to or embedded within one or more segments of the level. Any of these vials can be oriented such that it is aligned longitudinally with the segment with which it is associated. Alternatively, or in addition, one or more vials can be oriented so as to be perpendicular to the length of the segment, or oriented at a predetermined other angle with respect to the length of the segment. One or more of the vials can be arranged to be adjustable as to level angle, and any of the vials can be arranged to be visible from the top, bottom, and/or side of the level.

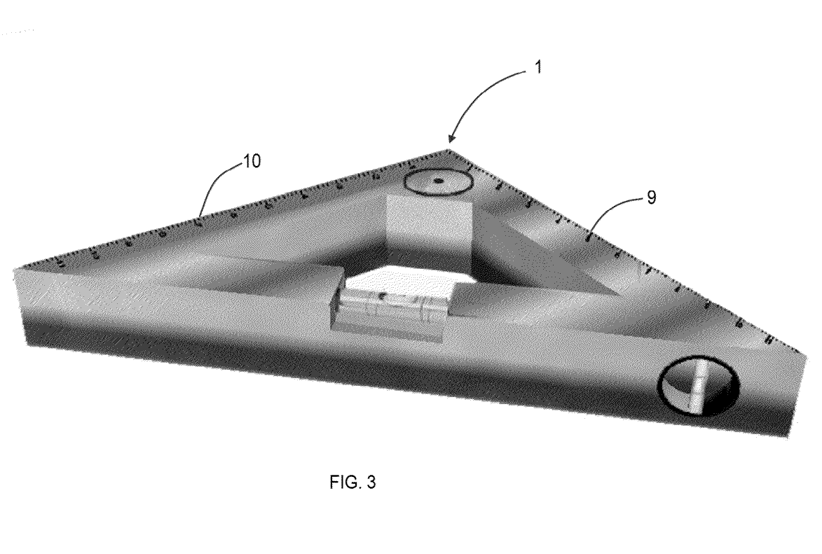

As shown in FIG. 3, one or more segments can include markings 9, 10 indicating distance measurement units. The markings facilitate measurement along surfaces abutted by the corner level. Of course, the marked edge can also be used as a ruler independently of any level measurement. Any useful desired measuring units, such as inches and centimeters, can be used.

Thus, one or more of the segments can be marked with measurement units along one edge or both edges, in the manner of a ruler. In this way, lengths can be measured as orientations are checked and surfaces are made level. Using the marked edge as a ruler, level lines can he measured and marked, for example, on a wall. The exemplary embodiments shown in the drawings figures are disclosed to have certain dimensions. It should be apparent to one of skill in the art that levels can be made to any dimensions or proportions, with measurement markings reading in units of any measurement system, within the spirit and scope of the present invention, which is not limited to the arrangements specifically shown in the drawings.

As described, the corner level can be held in a corner where a structure is to be leveled, or a level line is to be drawn. Arranged with the right angle flush into the corner, the leg segments are placed against the respective adjacent walls. Once in place, the vials associated with each leg segment can be checked for level orientation, and the level can be adjusted until both segments are level or oriented with respect to level as desired. A third level on the hypotenuse segment can be checked as well, to assure a level orientation across the angle of the walls. This process can easily be performed by a single person, and all segments can be checked and adjusted at the same time in a single operation.

Likewise, horizontal and vertical levels can be checked at the same time. For example, the top and one vertical side of a door frame can be levelled by holding the level against the inside corner of the door frame, with one level segment placed against the top of the frame to check for horizontal level, and the other level segment placed against the side of the frame to check for vertical level.

According to other applications, a mason, for example, can lay the level atop the corner of a wall with a leg segment aligned with a respective length of wall and the hypotenuse segment spanning the corner, to check and adjust the level of the wall at and around the corner. Similarly, a tile setter can level tiles set against the walls at a corner and also check the orientation of tiles spanning the corner. In summary, the invention is useful for levelling structures or objects or making level markings wherever surfaces meet at an angle, in a single operation using one tool.

Particular exemplary embodiments of the present invention have been described in detail. These exemplary embodiments are illustrative of the inventive concept recited in the appended claims, and are not limiting of the scope or spirit of the present invention as contemplated by the inventor.

I claim:

1. A level apparatus, comprising:
first, second, and third segments; and
a level-indicating device associated with one of the segments;
wherein each said segment has first and second ends, parallel top and bottom surfaces, and parallel front and back surfaces;
wherein the ends of the segments are joined to form a fixed triangular structure among the segments; and
wherein the level-indicating device is arranged to provide an indication of a level orientation of at least one of the surfaces of the segment with which it is associated.

2. The level apparatus of claim 1, wherein the top and bottom surfaces are flat and smooth.

3. The level apparatus of claim 1, wherein the front and back surfaces are flat and smooth.

4. The level apparatus of claim 1, wherein the first and second segments are joined together at a 90 degree angle.

5. The level apparatus of claim 4, wherein the level-indicating device is associated with the third segment.

6. The level apparatus of claim 1, wherein the level-indicating device is a first level-indicating device associated with the first segment, further comprising a second level-indicating device that is associated with the second segment.

7. The level apparatus of claim 6, further comprising a third level-indicating device that is associated with the third segment.

8. The level apparatus of claim 1, wherein the level-indicating device is attached to a surface of the segment.

9. The level apparatus of claim 1, wherein the level-indicating device is recessed within the segment.

10. The level apparatus of claim 1, wherein the level-indicating device includes a vial.

11. The level apparatus of claim 1, wherein at least one segment includes markings indicating distance measurement units.

12. The level apparatus of claim 11, wherein the markings include numerical indicia.
